(19) United States
(12) Patent Application Publication
(10) Pub. No.: US 2020/0235454 A1
(43) Pub. Date: Jul. 23, 2020

(54) HOLLOW-WAVEGUIDE-TO-PLANAR-WAVEGUIDE TRANSITION CIRCUIT

(71) Applicant: MITSUBISHI ELECTRIC CORPORATION, Tokyo (JP)

(72) Inventors: Hiromasa NAKAJIMA, Tokyo (JP); Akimichi HIROTA, Tokyo (JP); Naofumi YONEDA, Tokyo (JP); Takeshi OSHIMA, Tokyo (JP)

(73) Assignee: MITSUBISHI ELECTRIC CORPORATION, Tokyo (JP)

(21) Appl. No.: 16/306,422

(22) PCT Filed: Jul. 5, 2016
(86) PCT No.: PCT/JP2016/069894

§ 371 Date: Nov. 30, 2018

(51) Int. Cl. H01P 5/107

(52) U.S. Cl. CPC H01P 5/107

(57) ABSTRACT

A hollow-waveguide-to-planar-waveguide transition circuit includes: strip conductors formed on a first main surface of a dielectric substrate; a ground conductor formed on the back side, facing the strip conductors; a slot formed in the ground conductor; and a coupling conductor formed at a position to be electrically coupled with the strip conductors. The coupling conductor has: a main body portion electrically coupled with the strip conductors; and protruding portions protruding from the main body portion. The protruding portions are formed so as to face an end portion of the slot.

### TECHNICAL FIELD

The present invention relates to a transition circuit for converting a transmission mode between a hollow waveguide and a planar waveguide such as a microstrip line.

### BACKGROUND ART

In high-frequency transmission lines used in a high-frequency band such as a millimeter wave band or a microwave band, to couple a hollow waveguide and a planar waveguide such as a microstrip line or a coplanar line to each other, transition circuits for converting a transmission mode between the hollow waveguide and the planar waveguide are widely used. For example, Patent Literature 1 (Japanese Patent Application Publication No. 2010-56920) discloses a hollow-waveguide-to-microstrip-line transition circuit for coupling a hollow waveguide with a microstrip line.

The structure of the microstrip line disclosed in Patent Literature 1 includes a strip conductor and a conductor plate formed on a front surface of a dielectric substrate, a ground conductor disposed on the entire back surface of the dielectric substrate, and a plurality of connecting conductors disposed in the dielectric substrate and connecting the conductor plate to the ground conductor. The ground conductor is connected to an end portion of a rectangular waveguide, and this ground conductor has a rectangular slot to be electrically coupled with the end portion of the rectangular waveguide. The conductor plate and the ground conductor form a coplanar line structure. Furthermore, connecting conductors are arranged around the periphery of a short plane (short-circuit plane) of the end portion of the rectangular waveguide. By providing these connecting conductors, unnecessary radiation from the slot can be suppressed.

### CITATION LIST

### Patent Literatures

Patent Literature 1: Japanese Patent Application Publication No. 2010-56920 (for example, FIGS. 1 and 2, paragraphs [0013] to [0018], FIGS. 12 and 13, and paragraphs [0043] to [0049])

### SUMMARY OF INVENTION

### Technical Problem

However, with the structure disclosed in Patent Literature 1, there is the disadvantage that, because the connecting conductors are necessary for suppressing unnecessary radiation, the manufacturing process of the hollow-waveguide-to-microstrip-line transition circuit becomes complicated, thereby increasing manufacturing cost.

In view of the foregoing, an object of the present invention is to provide a hollow-waveguide-to-planar-waveguide transition circuit capable of suppressing unnecessary radiation as well as reducing manufacturing cost.

### Solution to Problem

In accordance with an aspect of the present invention, there is provided a hollow-waveguide-to-planar-waveguide transition circuit for transmitting a high-frequency signal. The hollow-waveguide-to-planar-waveguide transition circuit includes: a dielectric substrate having a first main surface and a second main surface which face each other in a thickness direction of the dielectric substrate; one or more strip conductors formed on the first main surface, extending in a first in-plane direction determined in advance; a ground conductor formed on the second main surface to face the one or more strip conductors in the thickness direction; one or more slots formed in the ground conductor and extending in a second in-plane direction different from the first in-plane direction on the second main surface; and a coupling conductor formed at a position to be electrically coupled with the one or more strip conductors on the first main surface, and disposed at a position facing the one or more slots in the thickness direction, the coupling conductor having a main body portion electrically coupled with the one or more strip conductors, and having a protruding portion protruding from the main body portion in the second in-plane direction, the protruding portion being formed and facing, in the thickness direction, an end portion of the one or more slots in the second in-plane direction.

### Advantageous Effects of Invention

In accordance with the present invention, a hollow-waveguide-to-planar-waveguide transition circuit can be provided which is capable of suppressing unnecessary radiation as well as achieving low manufacturing cost and high operation reliability.

### BRIEF DESCRIPTION OF DRAWINGS

FIG. 1 is a schematic plan view of a hollow-waveguide-to-planar-waveguide transition circuit of a first embodiment according to the present invention.

FIG. 2 is a schematic cross-sectional view taken along line II-II of the hollow-waveguide-to-planar-waveguide transition circuit illustrated in FIG. 1.

FIG. 3 is an enlarged view of a conductor portion of the first embodiment.

FIG. 4 is a view schematically illustrating a propagation direction of a high-frequency signal.

FIG. 5 is a schematic plan view of a conventional hollow-waveguide-to-microstrip-line transition circuit.

FIG. 6 is a schematic cross-sectional view taken along line VI-VI of the hollow-waveguide-to-planar-waveguide transition circuit illustrated in FIG. 5.

FIG. 7 is a schematic plan view of a hollow-waveguide-to-planar-waveguide transition circuit of a second embodiment according to the present invention.

FIG. 8 is a schematic plan view of a hollow-waveguide-to-planar-waveguide transition circuit of a third embodiment according to the present invention.

FIG. 9 is a schematic plan view of a hollow-waveguide-to-planar-waveguide transition circuit of a fourth embodiment according to the present invention.

FIG. 10 is a schematic cross-sectional view taken along line X-X of the hollow-waveguide-to-planar-waveguide transition circuit illustrated in FIG. 9.

FIG. 11 is a schematic plan view of a hollow-waveguide-to-planar-waveguide transition circuit of a fifth embodiment according to the present invention.

FIG. 12 is a schematic plan view of a hollow-waveguide-to-planar-waveguide transition circuit of a sixth embodiment according to the present invention.

FIG. 13 is a schematic plan view of a hollow-waveguide-to-planar-waveguide transition circuit of a seventh embodiment according to the present invention.

FIG. 14 is a schematic plan view of a hollow-waveguide-to-planar-waveguide transition circuit of an eighth embodiment according to the present invention.

FIG. 15 is a schematic cross-sectional view taken along line XV-XV of the hollow-waveguide-to-planar-waveguide transition circuit illustrated in FIG. 14.

FIG. 16 is a schematic plan view of a hollow-waveguide-to-planar-waveguide transition circuit of a ninth embodiment according to the present invention.

FIG. 17 is a schematic cross-sectional view taken along line XVII-XVII of the hollow-waveguide-to-planar-waveguide transition circuit illustrated in FIG. 16.

### DESCRIPTION OF EMBODIMENTS

Hereinafter, various embodiments according to the present invention will be described in detail with reference to the drawings. Note that constituent elements denoted by the same reference numeral throughout the drawings have the same configuration and the same function. X-axis, Y-axis, and Z-axis illustrated in the drawings are orthogonal to one another.

### First Embodiment

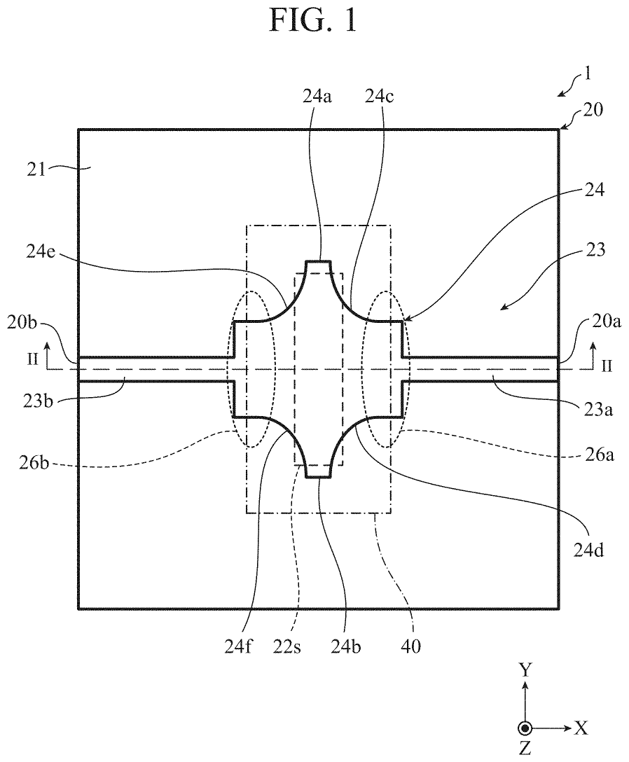

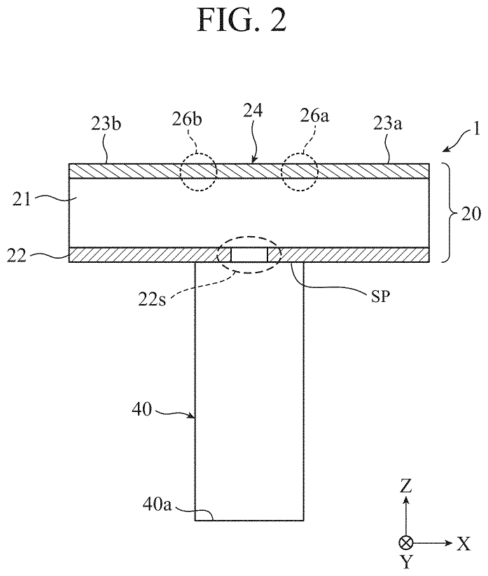

FIG. 1 is a view schematically illustrating the planar structure of a hollow-waveguide-to-planar-waveguide transition circuit 1 of a first embodiment according to the present invention. FIG. 2 is a schematic cross-sectional view taken along line II-II of the hollow-waveguide-to-planar-waveguide transition circuit 1 illustrated in FIG. 1.

As illustrated in FIGS. 1 and 2, the hollow-waveguide-to-planar-waveguide transition circuit 1 includes a planar waveguide structure 20 having input/output terminals 20a and 20b used for inputting and outputting a high-frequency signal, and a hollow waveguide 40 connected to the planar waveguide structure 20. The hollow-waveguide-to-planar-waveguide transition circuit 1 has a function of converting a transmission mode (particularly a transmission fundamental mode) of a high-frequency signal mutually between the hollow waveguide 40 and the planar waveguide structure 20, and has an impedance conversion function for converting a characteristic impedance mutually between the hollow waveguide 40 and the planar waveguide structure 20.

The hollow waveguide 40 is a metallic hollow-core waveguide having a rectangular cross section in a plane orthogonal to the guide axis of the hollow waveguide 40, that is, a rectangular waveguide. Although the tube thickness of the hollow waveguide 40 illustrated in FIG. 2 is omitted, there is a tube thickness of several millimeters actually. A hollow path of the hollow waveguide 40 extends in the guide-axis direction (Z-axis direction) of the hollow waveguide 40. The transmission fundamental mode of the hollow waveguide 40 is, for example, a TE₁₀ mode which is one of transverse electric modes (TE modes). Meanwhile, the transmission fundamental mode of the planar waveguide structure 20 is a quasi-transverse electromagnetic mode (quasi-TEM mode). The hollow-waveguide-to-planar-waveguide transition circuit 1 can convert a transmission fundamental mode of a high-frequency signal from one of the TE₁₀ mode and the quasi-TEM mode to the other.

As illustrated in FIG. 1, the planar waveguide structure 20 includes a dielectric substrate 21 having a quadrangle such as a square or a rectangle when viewed from the Z-axis direction, and a conductor pattern 23 formed on the front surface (first main surface) out of two facing surfaces of the dielectric substrate 21. Here, the front surface of the dielectric substrate 21 is parallel to an X-Y plane including the X-axis and the Y-axis. For example, the dielectric substrate 21 only needs to be formed of a dielectric material such as glass epoxy, polytetrafluoroethylene (PTFE), or ceramics.

The conductor pattern 23 includes two strip conductors 23a and 23b which are linear conductors extending in a predetermined in-plane direction (X-axis direction) on the front surface of the dielectric substrate 21, and a coupling conductor 24 interposed between the strip conductors 23a and 23b and physically connected to the strip conductors 23a and 23b.

As illustrated in FIG. 2, the planar waveguide structure 20 includes a ground conductor 22 which is a conductive film formed over the entire back surface (second main surface) of the dielectric substrate 21, a slot 22s which is a coupling window formed in the ground conductor 22, and the hollow waveguide 40 having one end portion connected to a predetermined area (including the slot 22s) of the ground conductor 22. The back surface of the dielectric substrate 21 is parallel to the X-Y plane. As illustrated in FIG. 1, the slot 22s extends in the Y-axis direction different from an extending direction (X-axis direction) of the strip conductors 23a and 23b, and has a rectangular shape having the Y-axis direction as a longitudinal direction.

The guide-axis direction of the hollow waveguide 40 is parallel to the Z-axis direction. A wall surface forming one end portion of the hollow waveguide 40 on the positive side of the Z-axis direction is physically connected to the ground conductor 22 to form a short plane (short-circuit plane) SP. The outer shape of the hollow waveguide 40 illustrated in FIG. 1 is a rectangular shape and represents the outer shape of the short plane SP. The other end portion of the hollow waveguide 40 on the negative side of the Z-axis direction constitutes an input/output terminal 40a for use in input and output of a high-frequency signal.

The ground conductor 22 and the conductor pattern 23 can be formed by plating, for example. As a constituent material of the conductor pattern 23 and the ground conductor 22, it is only required to use, for example, any one of conductive materials such as copper, silver, and gold, or a combination of two or more materials selected from these conductive materials.

As illustrated in FIGS. 1 and 2, the coupling conductor 24 is disposed at a position facing the slot 22s disposed on the back side of the dielectric substrate 21 in the Z-axis direction (thickness direction of the dielectric substrate 21). As illustrated in FIG. 1, the coupling conductor 24 has a substantially rectangular main body portion connected to inner end portions of the strip conductors 23a and 23b, a protruding portion 24a protruding from the main body portion in the Y-axis positive direction, and a protruding portion 24b protruding from the main body portion in the Y-axis negative direction. Impedance adjusting units 26a and 26b are formed near both ends of the main body portion in the X-axis direction.

As illustrated in FIG. 1, the protruding portion 24a which is one of the protruding portions of the coupling conductor 24 is formed so as to face, in the Z-axis direction, the end portion of the slot 22s on the positive side of the Y-axis direction, and the protruding portion 24b which is the other protruding portion is formed so as to face, in the Z-axis direction, the end portion of the slot 22s on the negative side of the Y-axis direction. A tip of the protruding portion 24a which is one of the protruding portions is disposed on the positive side of the Y-axis direction and outside one end portion of the slot 22s in a longitudinal direction of the slot 22s. A tip of the protruding portion 24b which is the other protruding portion is disposed on the negative side of the Y-axis direction and outside the other end portion of the slot 22s in the longitudinal direction.

The protruding portion 24a which is one of the protruding portions has a pair of inclined portions 24c and 24e which form a tapered shape. That is, the protruding portion 24a has a tapered shape in which the lateral width (width in the X-axis direction) of the protruding portion 24a changes in a manner that gradually decreases the lateral width as the location of the lateral width changes from the main body portion toward the tip of the protruding portion 24a. The protruding portion 24b which is the other protruding portion also has a pair of inclined portions 24d and 24f which form a tapered shape. That is, the protruding portion 24b has a tapered shape in which the lateral width of the protruding portion 24b changes in a manner that gradually decreases the lateral width as the location of the lateral width changes from the main body portion toward the tip of the protruding portion 24b.

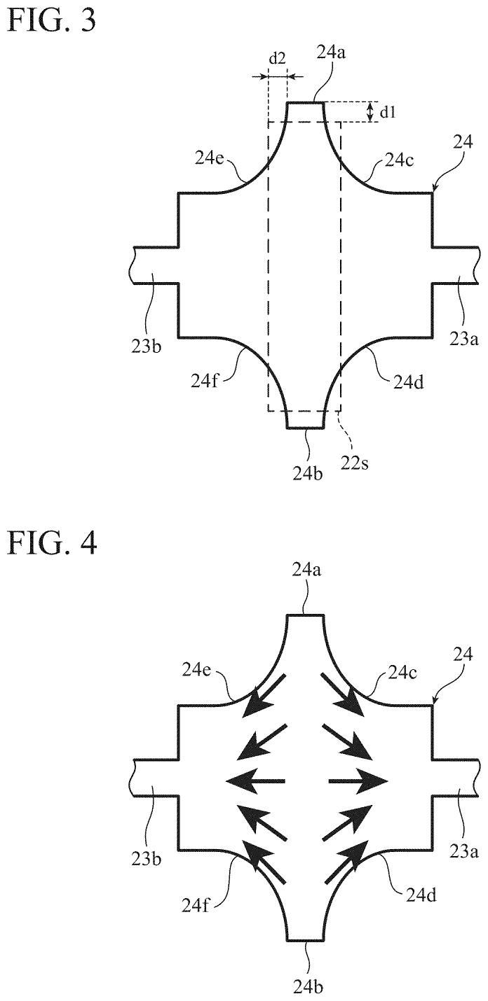

Furthermore, as illustrated in FIG. 1, each of the tips of the protruding portions 24a and 24b has a certain lateral width. The lateral width of the tip of the protruding portion 24a which is one of the protruding portions is narrower than the lateral width of one end portion of the slot 22s, and the lateral width of the tip of the protruding portion 24b which is the other protruding portion is also narrower than the lateral width of the other end portion of the slot 22s. FIG. 3 is an enlarged view of the coupling conductor 24 illustrated in FIG. 1. As illustrated in FIG. 3, a distance d1 in a longitudinal direction (Y-axis direction) between the tip of one end portion of the slot 22s and the tip of the protruding portion 24a is set so as to be equal to or less than one eighth (=λ/8) of a wavelength A corresponding to a center frequency of a predetermined frequency band to be used. A distance in the longitudinal direction between the tip of the other end portion of the slot 22s and the tip of the protruding portion 24b is similarly set so as to be equal to or less than λ/8.

As illustrated in FIG. 3, a distance d2 in a lateral direction between the tip of the protruding portion 24a and the left end of one end portion of the slot 22s in the lateral direction (X-axis direction) is set so as to be equal to or less than one eighth of the wavelength A. A distance in a lateral direction between the tip of the protruding portion 24a and the right end of the other end portion of the slot 22s in the lateral direction is also set similarly. A distance in a lateral direction between the tip of the protruding portion 24b which is the other protruding portion and the left end or the right end of one end portion of the slot 22s in the lateral direction is also set so as to be equal to or less than one eighth of the wavelength λ. Therefore, the distance in each of the longitudinal direction and the lateral direction between the tip of the protruding portion 24a and an edge of one end portion of the slot 22s is set so as to be within one eighth of the wavelength λ. Similarly, the distance in each of the longitudinal direction and the lateral direction between the tip of the protruding portion 24b and an edge of the other end portion of the slot 22s is set so as to be within one eighth of the wavelength λ.

Next, operation of the hollow-waveguide-to-planar-waveguide transition circuit 1 of the present embodiment will be described with reference to FIGS. 1 and 2.

In the planar waveguide structure 20 of the present embodiment, the strip conductors 23a and 23b, the ground conductor 22 facing the strip conductors 23a and 23b, and a dielectric interposed between the ground conductor 22 and the strip conductors 23a and 23b form a microstrip line. The coupling conductor 24, the ground conductor 22 facing the coupling conductor 24, and a dielectric interposed between the ground conductor 22 and the coupling conductor 24 form a parallel flat line.

When a high-frequency signal is input to the input/output terminal 40a of the hollow waveguide 40, the input high-frequency signal excites the slot 22s. Because the longitudinal direction of the slot 22s intersects the longitudinal direction (extending direction) of the strip conductors 23a and 23b, the excited slot 22s and the strip conductors 23a and 23b are magnetically coupled with each other. The high-frequency signal is propagated via the parallel flat line to the input/output terminals 20a and 20b of the microstrip line and output. At this time, the slot 22s is excited in the same phase. The strip conductors 23a and 23b are disposed so as to extend in opposite directions to each other with respect to the slot 22s. Therefore, the input/output terminals 20a and 20b perform output in opposite phases to each other. Conversely, when high-frequency signals in opposite phases to each other are input to the input/output terminals 20a and 20b of the planar line structure 20, these high-frequency signals are combined and then output from the input/output terminal 40a of the hollow waveguide 40.

Because the direction of an electric field formed in the slot 22s is parallel to a short-axis direction (X-axis direction) of the slot 22s, a parallel flat mode in a direction parallel to the extending direction of the strip conductors 23a and 23b is generated. Electric field intensity in the slot 22s is largest at a midportion of the slot 22s and is zero at an end portion of the slot 22s. Therefore, the electric field intensity at an end portion of the parallel flat line in the Y-axis direction (that is, a line portion near the tips of the protruding portions 24a and 24b) is extremely weak, and the amount of unnecessary radiation from the end portion of the parallel flat line in the Y-axis direction is small in a direction orthogonal to a travelling direction of a high-frequency signal. FIG. 4 is a view schematically illustrating a propagation direction of a high-frequency signal transmitted between the coupling conductor 24 and the ground conductor 22 when viewed from the Z-axis direction. As illustrated in FIG. 4, the high-frequency signal propagated from the hollow waveguide 40 is distributed to the two strip conductors 23a and 23b via the slot 22s. Due to the tapered structure of the coupling conductor 24, the propagation direction of the high-frequency signal can be gradually changed continuously, and the traveling direction of the high-frequency signal can be directed toward the strip conductors 23a and 23b. This makes it possible to efficiently propagate the high-frequency signal to the strip conductors 23a and 23b while suppressing unnecessary radiation.

Furthermore, as illustrated in FIG. 3, the size of the tip portion covering one end portion of the slot 22s in the protruding portion 24a in the Y-axis direction is about the same as the size of one end portion of the slot 22s. The size of the tip portion covering the other end portion of the slot 22s in the protruding portion 24b in the Y-axis direction is also about the same as the size of the other end portion of the slot 22s. Therefore, at the both end portions of the slot 22s in the Y-axis direction, because the covering area where the slot 22s is covered with the protruding portions 24a and 24b is small, a parallel flat mode is hardly generated. As a result, the high-frequency signal concentrates on the midportion of the slot 22s and is propagated from the midportion of the slot 22s toward the strip conductors 23a and 23b in the parallel flat mode, and therefore efficient conversion can be executed while unnecessary radiation is suppressed.

In short, the size of each of the tip portions of the protruding portions 24a and 24b covering the both end portions of the slot 22s in the Y-axis direction is about the same as the size of each of the both end portions of the slot 22s, and a tapered structure is formed in the coupling conductor 24. As a result, the high-frequency signal can be efficiently transmitted to the strip conductors 23a and 23b while unnecessary radiation is suppressed.

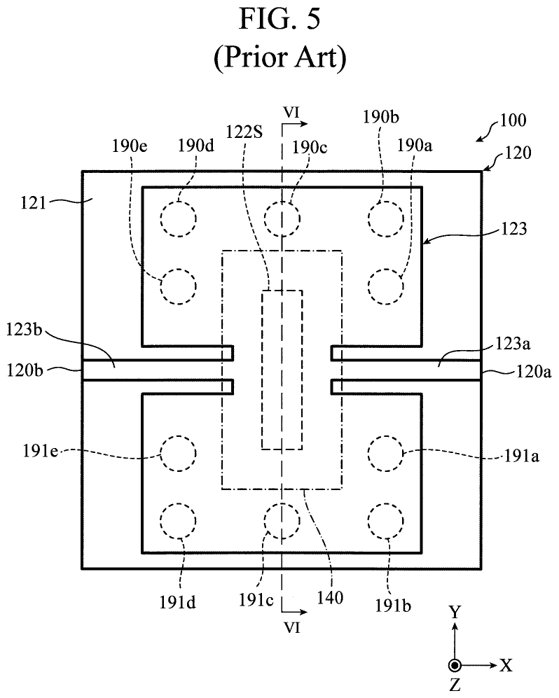

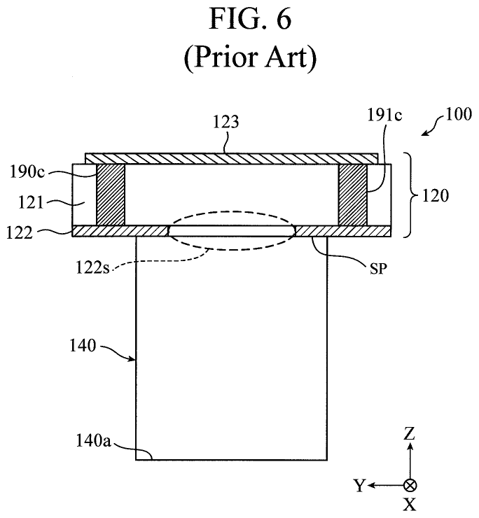

The hollow-waveguide-to-planar-waveguide transition circuit 1 of the present embodiment can suppress unnecessary radiation without requiring a connecting conductor connecting the conductor pattern 23 on the front surface of the dielectric substrate 21 and the ground conductor 22 on the back surface of the dielectric substrate 21 to each other. FIG. 5 is a view schematically illustrating a planar waveguide structure 120 of a conventional hollow-waveguide-to-microstrip-line transition circuit 100 including such connecting conductors 190a to 190e and 191a to 191e. FIG. 6 is a schematic cross-sectional view taken along line VI-VI of the hollow-waveguide-to-microstrip-line transition circuit 100 illustrated in FIG. 5. A configuration substantially the same as that of the hollow-waveguide-to-microstrip-line transition circuit 100 is disclosed in Patent Literature 1 (Japanese Patent Application Publication No. 2010-56920).

As illustrated in FIG. 5, the planar waveguide structure 120 of the hollow-waveguide-to-microstrip-line transition circuit 100 includes: strip conductors 123a and 123b formed on the front surface of a dielectric substrate 121; a conductor plate 123 formed so as to be connected to the strip conductors 123a and 123b on the front surface; a ground conductor 122 formed on the back surface of the dielectric substrate 121; a rectangular slot 122S formed in the ground conductor 122; and columnar connecting conductors 190a to 190e and 191a to 191e disposed in the dielectric substrate 121 and connecting the conductor plate 123 to the ground conductor 122. As illustrated in FIG. 4, an end portion of a rectangular waveguide 140 is in contact with the ground conductor 122 to form a short plane (short-circuit plane) SP. The connecting conductors 190a to 190e and 191a to 191e are disposed so as to surround the short plane SP of the rectangular waveguide 140.

When a high-frequency signal is input to the input/output terminal 140a of the hollow waveguide 140, the input high-frequency signal excites the slot 122S. Because the longitudinal direction of the slot 122S intersects the longitudinal direction of the strip conductors 123a and 123b, the excited slot 122s and the strip conductors 123a and 123b are magnetically coupled with each other. The high-frequency signal is output from the input/output terminals 120a and 120b of a microstrip line formed by the strip conductors 123a and 123b and the ground conductor 122 via a parallel flat line formed by the conductor plate 123 and the ground conductor 122. The hollow-waveguide-to-microstrip-line transition circuit 100 can suppress unnecessary radiation from the slot 122S by disposing the connecting conductors 190a to 190e and 191a to 191e.

In order to dispose the connecting conductors 190a to 190e and 191a to 191e, for example, a step of forming a through hole passing from the front surface to the back surface in the dielectric substrate 121 and a step of forming a conductor in the through hole (for example, a plating step and an etching step) are required. However, these steps complicate a process for manufacturing the hollow-waveguide-to-microstrip-line transition circuit 100, and increase its manufacturing cost.

When the dielectric substrate 121 of the hollow-waveguide-to-microstrip-line transition circuit 100 expands and contracts due to temperature change, tension is applied to the connecting conductors 190a to 190e and 191a to 191e. As a result, the connecting conductors 190a to 190e and 191a to 191e may be broken, or characteristics of the hollow-waveguide-to-microstrip-line transition circuit 100 may be deteriorated.

Meanwhile, the hollow-waveguide-to-planar-waveguide transition circuit 1 of the present embodiment can suppress unnecessary radiation without requiring a connecting conductor, and therefore can realize lower manufacturing cost and higher operation reliability than the hollow-waveguide-to-microstrip-line transition circuit 100.

As described above, because the coupling conductor 24 has the protruding portions 24a and 24b facing the both end portions of the slot 22s, the hollow-waveguide-to-planar-waveguide transition circuit 1 of the first embodiment can achieve low manufacturing cost and high operation reliability while suppressing unnecessary radiation. In addition, because the structure of the present embodiment does not require the connecting conductors 190a to 190e and 191a to 191e unlike the conventional hollow-waveguide-to-microstrip-line transition circuit 100, and can downsize the hollow-waveguide-to-planar-waveguide transition circuit 1.

### Second Embodiment

Although the first embodiment has a structure in which the strip conductors 23a and 23b and the coupling conductor 23c are physically connected to each other in the impedance adjusting units 26a and 26b, although no limitation thereto is intended. The first embodiment may be modified so as to have a structure having a strip conductor and a coupling conductor physically separated from each other. Second and third embodiments each having such a structure will be described below.

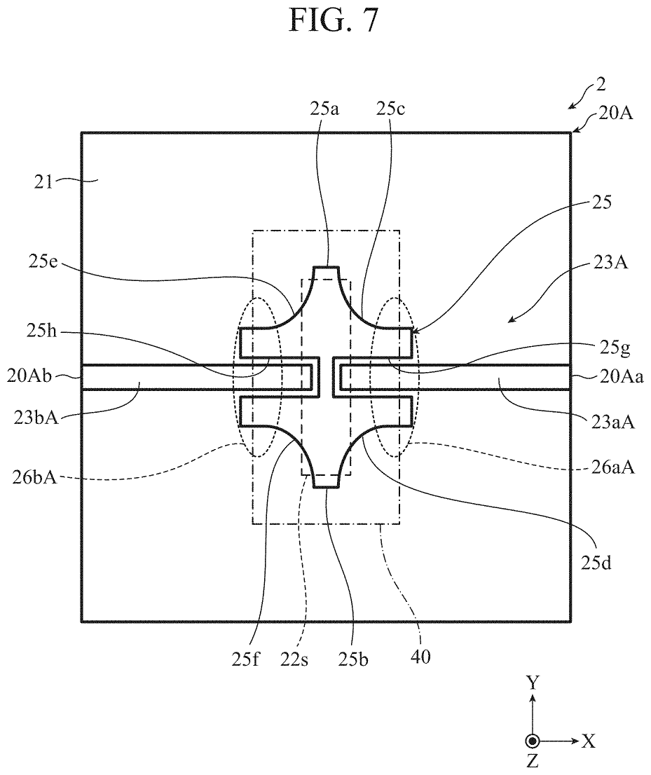

FIG. 7 is a view schematically illustrating the planar structure of a hollow-waveguide-to-planar-waveguide transition circuit 2 of the second embodiment which is a first modification of the first embodiment. The configuration of the hollow-waveguide-to-planar-waveguide transition circuit 2 is the same as that of the hollow-waveguide-to-planar-waveguide transition circuit 1 of the first embodiment except for having a conductor pattern 23A of FIG. 7 instead of the conductor pattern 23 of FIG. 1. A step of forming the conductor pattern 23A is the same as the step of forming the conductor pattern 23.

As illustrated in FIG. 7, the hollow-waveguide-to-planar-waveguide transition circuit 2 of the present embodiment includes a planar waveguide structure 20A having input/output terminals 20Aa and 20Ab, and the planar waveguide structure 20A has the conductor pattern 23A on the front surface of a dielectric substrate 21. The conductor pattern 23A includes strip conductors 23aA and 23bA physically separated from each other in the X-axis direction and a coupling conductor 25. Like the coupling conductor 24 of the first embodiment, the coupling conductor 25 has protruding portions 25a and 25b protruding from a main body portion of the coupling conductor 25 in the Y-axis direction. The protruding portions 25a and 25b have inclined portions 25c, 25e, 25d, and 25f which form tapered shapes, and are disposed so as to face, in the Z-axis direction, both end portions of a slot 22s in the Y-axis direction. The shapes, dispositions, and functions of these protruding portions 25a and 25b are the same as those of the protruding portions 24a and 24b of the first embodiment.

The coupling conductor 25 has a recessed portion 25g recessed in the X-axis negative direction and a recessed portion 25h recessed in the X-axis positive direction. An inner end portion of the strip conductor 23aA which is one of the strip conductors is surrounded by a recessed portion 23g, and an inner end portion of the strip conductor 23bA which is the other strip conductor is surrounded by a recessed portion 23h. The structure of the coupling conductor 25 of the present embodiment is substantially the same as the structure in which the recessed portions 23g and 23h are formed by processing the coupling conductor 24 of the first embodiment. As illustrated in FIG. 7, impedance adjusting units 26aA and 26bA of the present embodiment are formed near the recessed portions 25g and 25h.

Because the coupling conductor 25 has the protruding portions 25a and 25b facing the both end portions of the slot 22s as in the first embodiment, the hollow-waveguide-to-planar-waveguide transition circuit 2 of the present embodiment also can achieve low manufacturing cost and high operation reliability while suppressing unnecessary radiation.

### Third Embodiment

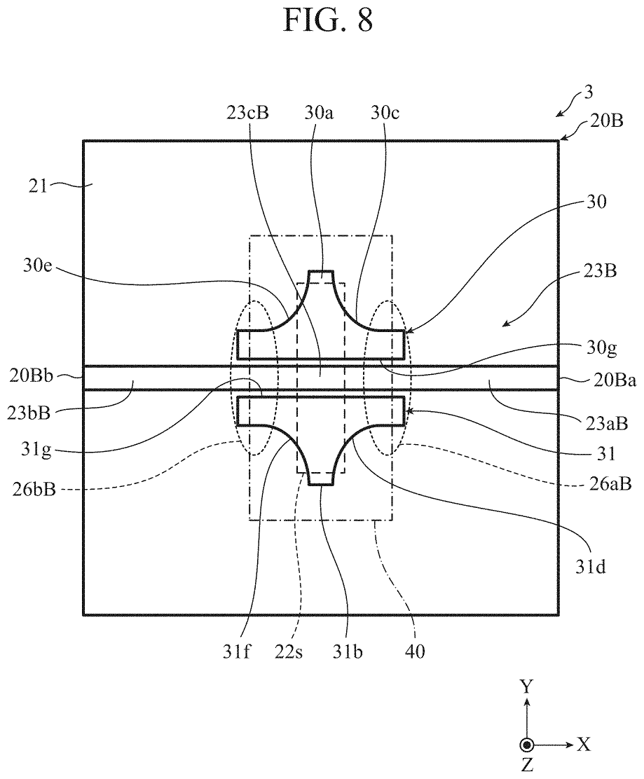

FIG. 8 is a view schematically illustrating the planar structure of a hollow-waveguide-to-planar-waveguide transition circuit 3 of a third embodiment according to the present invention. The configuration of the hollow-waveguide-to-planar-waveguide transition circuit 3 is the same as that of the hollow-waveguide-to-planar-waveguide transition circuit 1 of the first embodiment except for having a conductor pattern 23B of FIG. 8 instead of the conductor pattern 23 of FIG. 1. A step of forming the conductor pattern 23B is the same as the step of forming the conductor pattern 23.

As illustrated in FIG. 8, the hollow-waveguide-to-planar-waveguide transition circuit 3 of the present embodiment includes a planar waveguide structure 20B having input/output terminals 20Ba and 20Bb, and the planar waveguide structure 20B has the conductor pattern 23B on the front surface of a dielectric substrate 21. The conductor pattern 23B includes strip conductors 23aB and 23bB connected via a connecting portion 23cB in the X-axis direction, a first coupling conductor 30, and a second coupling conductor 31. The first coupling conductor 30 and the second coupling conductor 31 constitute a coupling conductor of the present embodiment.

Like the coupling conductor 24 of the first embodiment, the first coupling conductor 30 has a protruding portion 30a protruding from a main body portion of the first coupling conductor 30 in the Y-axis positive direction, and the second coupling conductor 31 has a protruding portion 31b protruding from a main body portion of the second coupling conductor 31 in the Y-axis negative direction. The protruding portions 30a and 31b have inclined portions 30c, 30e, 31d, and 31f which form tapered shapes, and are disposed so as to face, in the Z-axis direction, both end portions of a slot 22s in the Y-axis direction. The shapes, dispositions, and functions of these protruding portions 30a and 31b are the same as those of the protruding portions 24a and 24b of the first embodiment.

The first coupling conductor 30 and the second coupling conductor 30 are physically separated from each other, and the strip conductors 23aB and 23bB and the connecting portion 23cB are disposed in an area between the first coupling conductor 30 and the second coupling conductor 31. As illustrated in FIG. 8, impedance adjusting units 26aB and 26bB of the present embodiment are formed near both ends of the first coupling conductor 30 and the second coupling conductor 31 in the X-axis direction, respectively.

Because the first coupling conductor 30 and the second coupling conductor 31 have the protruding portions 30a and 31b facing the both end portions of the slot 22s as in the first embodiment, the hollow-waveguide-to-planar-waveguide transition circuit 3 of the present embodiment also can achieve low manufacturing cost and high operation reliability while suppressing unnecessary radiation.

### Fourth Embodiment

Each of the above-described hollow-waveguide-to-planar-waveguide transition circuits 1 to 3 of the first to third embodiments has the single slot 22s, although no limitation thereto is intended. The first to third embodiments may be modified so as to include two or more slots. Fourth, fifth, and sixth embodiments each including a plurality of slots will be described below.

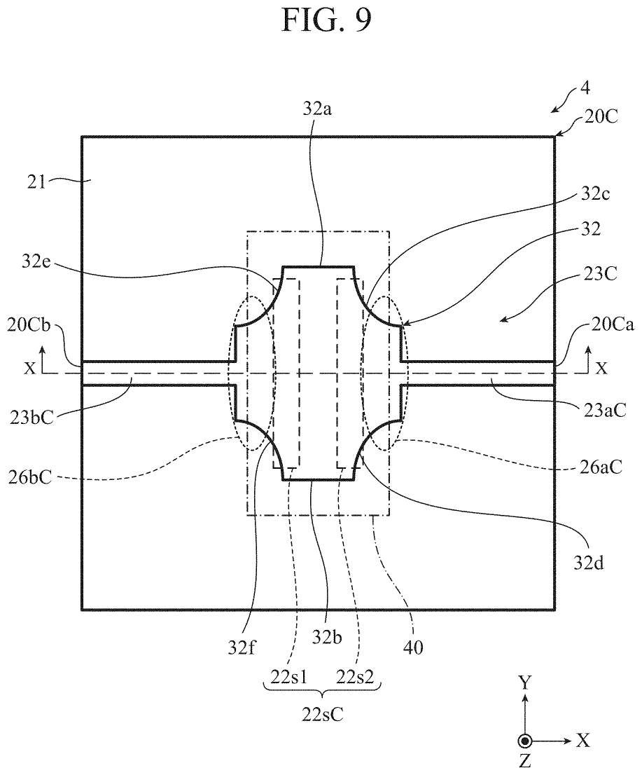

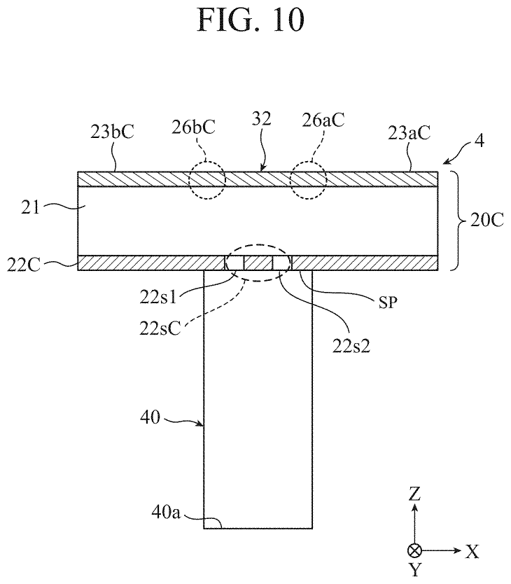

FIG. 9 is a view schematically illustrating the planar structure of a hollow-waveguide-to-planar-waveguide transition circuit 4 of a fourth embodiment according to the present invention. FIG. 10 is a schematic cross-sectional view taken along line X-X of the hollow-waveguide-to-planar-waveguide transition circuit 4 illustrated in FIG. 9.

The hollow-waveguide-to-planar-waveguide transition circuit 4 of the present embodiment includes a planar line structure 20C having input/output terminals 20Ca and 20Cb as illustrated in FIG. 9, and the planar line structure 20C has a conductor pattern 23C on the front surface of a dielectric substrate 21. As illustrated in FIG. 10, a ground conductor 22C is disposed on the back surface of the dielectric substrate 21. In the ground conductor 22C, a slot group 22sC including rectangular slots 22s1 and 22s2 extending in the Y-axis direction is formed.

The conductor pattern 23C includes strip conductors 23aC and 23bC extending in the X-axis direction and a coupling conductor 32 electrically coupled with the strip conductors 23aC and 23bC. The strip conductors 23aB and 23bB are disposed so as to extend in opposite directions (X-axis positive direction and X-axis negative direction) to each other with respect to the slot group 22sC. A main body portion of the coupling conductor 32 of the present embodiment is physically connected to inner end portions of the strip conductors 23aC and 23bC.

Like the coupling conductor 24 of the first embodiment, the coupling conductor 32 has protruding portions 32a and 32b protruding from the main body portion of the coupling conductor 32 in the Y-axis direction, and these protruding portions 32a and 32b have inclined portions 32c, 32e, 32d, and 32f which form tapered shapes, and are disposed so as to face, in the Z-axis direction, both end portions of a slot 22s in the Y-axis direction. As illustrated in FIG. 9, impedance adjusting units 26aC and 26bC of the present embodiment are formed near the both ends of the main body portion of the coupling conductor 32 in the X-axis direction.

The lateral width (width in the X-axis direction) of a tip of the protruding portion 32a is narrower than the entire width of the slot group 22sC including the slots 22s1 and 22s2, and the lateral width (width in the X-axis direction) of a tip of the protruding portion 32b is also narrower than the entire width of the slot group 22sC including the slots 22s1 and 22s2. A distance in each of a longitudinal direction (Y-axis direction) and a lateral direction (X-axis direction) between an edge of one end portion of the slot group 22sC in the Y-axis direction and the tip of the protruding portion 32a is set so as to be equal to or less than one eighth (=λ/8) of the wavelength A corresponding to a center frequency of a frequency band to be used. A distance in each of the longitudinal direction and the lateral direction between an edge of the other end portion of the slot group 22sC in the Y-axis direction and the tip of the protruding portion 32b is similarly set so as to be equal to or less than λ/8.

As illustrated in FIG. 9, the size of the tip portion covering one end portion of the slot group 22sC in the protruding portion 32a in the Y-axis direction is about the same as the size of one end portion of the slot group 22sC. The size of the tip portion covering the other end portion of the slot group 22sC in the protruding portion 32b in the Y-axis direction is also about the same as the size of the other end portion of the slot group 22sC. Therefore, the function of the protruding portions 32a and 32b is substantially the same as the function of the protruding portions 24a and 24b of the first embodiment. Therefore, it is possible to efficiently transmit a high-frequency signal to the strip conductors 23aC and 23bC while suppressing unnecessary radiation.

As described above, the hollow-waveguide-to-planar-waveguide transition circuit 4 of the present embodiment also can achieve low manufacturing cost and high operation reliability while suppressing unnecessary radiation as in the first embodiment.

### Fifth Embodiment

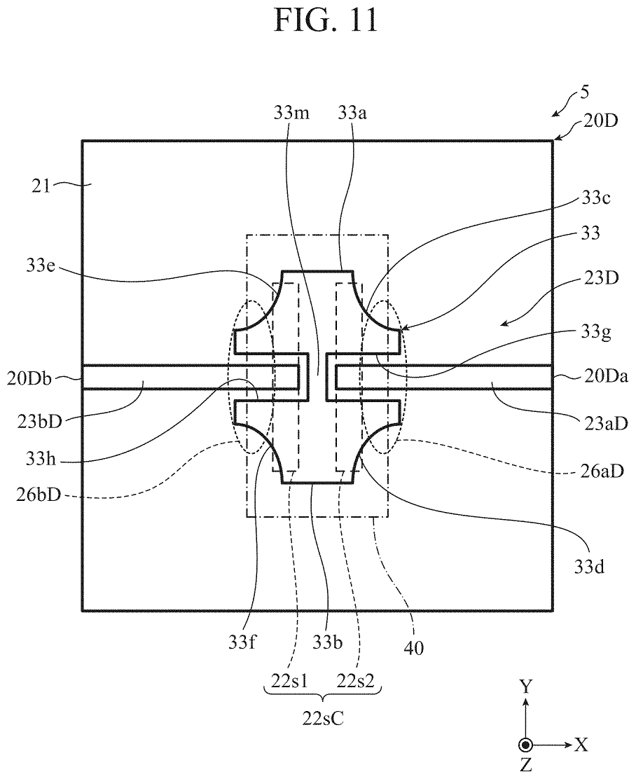

FIG. 11 is a view schematically illustrating the planar structure of a hollow-waveguide-to-planar-waveguide transition circuit 5 of a fifth embodiment according to the present invention. The hollow-waveguide-to-planar-waveguide transition circuit 5 of the present embodiment includes a planar line structure 20D having input/output terminals 20Da and 20Db as illustrated in FIG. 11, and the planar line structure 20D has a conductor pattern 23D on the front surface of a dielectric substrate 21. A ground conductor 22C is disposed on the back surface of the dielectric substrate 21 as in the fourth embodiment. In the ground conductor 22C, a slot group 22sC including rectangular slots 22s1 and 22s2 extending in the Y-axis direction is formed. The strip conductors 23aD and 23bD are disposed so as to extend in opposite directions to each other with respect to the slot group 22sC.

The conductor pattern 23D includes strip conductors 23aD and 23bD physically separated from each other in the X-axis direction and a coupling conductor 33. Like the coupling conductor 32 (FIG. 9) of the fourth embodiment, the coupling conductor 33 has protruding portions 33a and 33b protruding from a main body portion of the coupling conductor 33 in the Y-axis direction, and a connecting portion 33m connecting the protruding portions 33a and 33b to each other. The connecting portion 33m is disposed between the strip conductors 23aA and 23bA.

The protruding portions 33a and 33b have inclined portions 33c, 33e, 33d, and 33f which form tapered shapes, and are disposed so as to face, in the Z-axis direction, both end portions of a slot 22s in the Y-axis direction. The lateral width (width in the X-axis direction) of a tip of the protruding portion 33a is narrower than the entire width of the slot group 22sC including the slots 22s1 and 22s2, and the lateral width (width in the X-axis direction) of a tip of the protruding portion 33b is also narrower than the entire width of the slot group 22sC including the slots 22s1 and 22s2. The shapes, dispositions, and functions of these protruding portions 33a and 33b are the same as those of the protruding portions 32a and 32b of the fourth embodiment.

Meanwhile, the coupling conductor 33 has a recessed portion 33g recessed in the X-axis negative direction and a recessed portion 33h recessed in the X-axis positive direction. An inner end portion of the strip conductor 23aD which is one of the strip conductors is surrounded by the recessed portion 33g, and an inner end portion of the strip conductor 23bA which is the other strip conductor is surrounded by the recessed portion 33h. As illustrated in FIG. 11, impedance adjusting units 26aD and 26bD of the present embodiment are formed near the recessed portions 33g and 33h.

Because the coupling conductor 33 has the protruding portions 33a and 33b facing the both end portions of the slots 22s1 and 22s2 as in the first embodiment, the hollow-waveguide-to-planar-waveguide transition circuit 5 of the present embodiment also can achieve low manufacturing cost and high operation reliability while suppressing unnecessary radiation.

### Sixth Embodiment

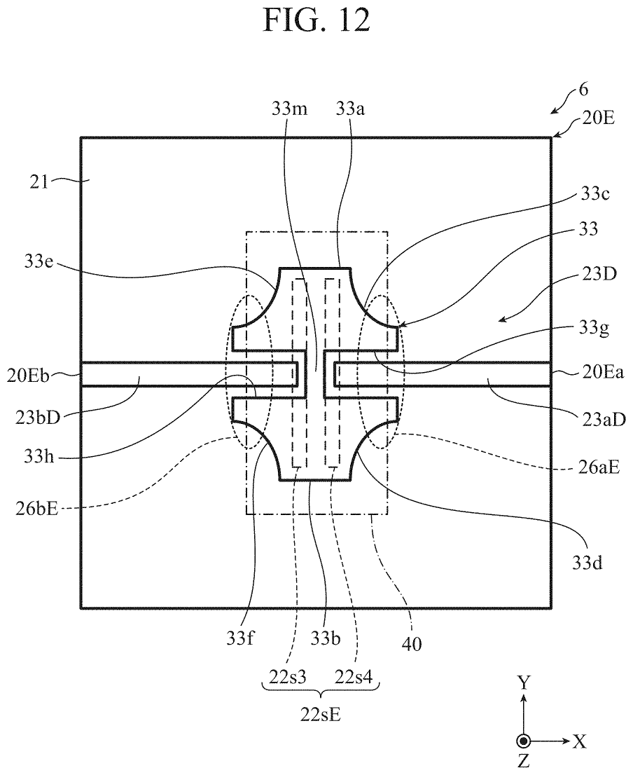

FIG. 12 is a view schematically illustrating the planar structure of a hollow-waveguide-to-planar-waveguide transition circuit 6 of a sixth embodiment which is a modification of the fifth embodiment. The configuration of the hollow-waveguide-to-planar-waveguide transition circuit 6 is the same as that of the hollow-waveguide-to-planar-waveguide transition circuit 5 of the fifth embodiment except for having a slot group 22sE of FIG. 12 instead of the slot group 22sC of FIG. 11.

The hollow-waveguide-to-planar-waveguide transition circuit 6 of the present embodiment includes a planar line structure 20E having input/output terminals 20Ea and 20Eb as illustrated in FIG. 12, and the planar line structure 20E has a conductor pattern 23D on the front surface of a dielectric substrate 21 as in the fifth embodiment. In a ground conductor on the back surface of the dielectric substrate 21, the slot group 22sE including rectangular slots 22s3 and 22s4 extending in the Y-axis direction is formed. As illustrated in FIG. 12, a distance between the slots 22s3 and 22s4 of the present embodiment in the X-axis direction is narrower than a distance between the slots 22s1 and 22s2 of the fifth embodiment in the X-axis direction. Therefore, the protruding portions 33a and 33b cover the entire slots 22s3 and 22s4 when viewed from the Z-axis direction. In the present embodiment, as in the fifth embodiment, impedance adjusting units 26aE and 26bE are formed near recessed portions 33g and 33h of a coupling conductor 33.

Because the coupling conductor 33 has the protruding portions 33a and 33b facing the both end portions of the slots 22s3 and 22s3 as in the fifth embodiment, the hollow-waveguide-to-planar-waveguide transition circuit 6 of the present embodiment also can achieve low manufacturing cost and high operation reliability while suppressing unnecessary radiation.

### Seventh Embodiment

Although the protruding portions 24a, 24b, 25a, 25b, 30a, 30b, 32a, 32b, 33a, and 33b of the first to sixth embodiments have tapered shapes, no limitation thereto is intended. The outer shapes of the protruding portions 24a, 24b, 25a, 25b, 30a, 30b, 32a, 32b, 33a, and 33b of the first to sixth embodiments may be changed to have stair shapes in which the lateral width of each of the protruding portions changes in a manner that stepwise decreases the lateral width as the location of the lateral width changes from the main body portion of a coupling conductor toward a tip of each of the protruding portions.

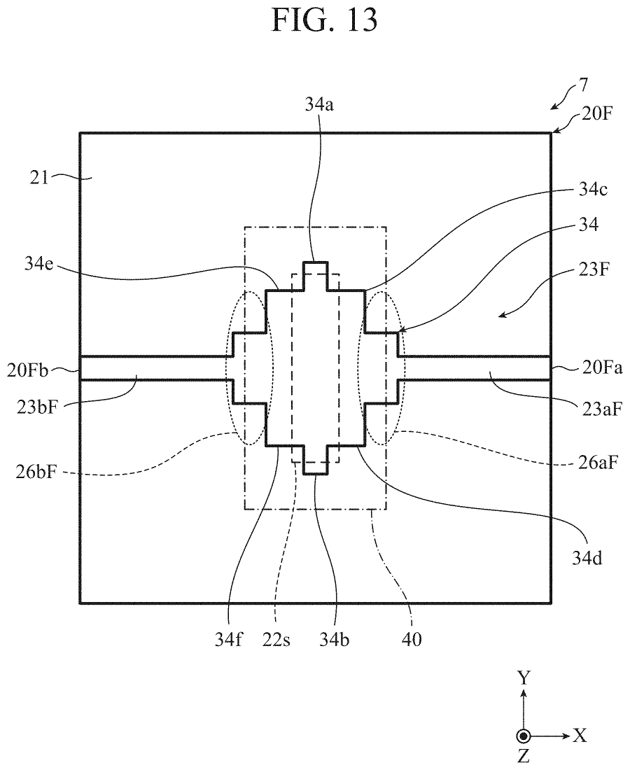

FIG. 13 is a view schematically illustrating the planar structure of a hollow-waveguide-to-planar-waveguide transition circuit 7 of a seventh embodiment which is a first modification of the first embodiment. The configuration of the hollow-waveguide-to-planar-waveguide transition circuit 7 is the same as that of the hollow-waveguide-to-planar-waveguide transition circuit 1 of the first embodiment except for having a conductor pattern 23F of FIG. 13 instead of the conductor pattern 23 of FIG. 1. A step of forming the conductor pattern 23F is the same as the step of forming the conductor pattern 23.

As illustrated in FIG. 13, the hollow-waveguide-to-planar-waveguide transition circuit 7 of the present embodiment includes a planar waveguide structure 20F having input/output terminals 20Fa and 20Fb, and the planar waveguide structure 20F has the conductor pattern 23F on the front surface of a dielectric substrate 21. The conductor pattern 23F includes strip conductors 23aF and 23bF extending in the X-axis direction and a coupling conductor 34. The coupling conductor 34 has a main body portion electrically coupled with the strip conductors 23aF and 23bF, a protruding portion 34a protruding from the main body portion in the Y-axis positive direction, and a protruding portion 34b protruding from the main body portion in the Y-axis negative direction.

The protruding portion 34a which is one of the protruding portions has a pair of inclined portions 34c and 34e which form a stair shape. That is, the protruding portion 34a has a stair shape in which the lateral width (width in the X-axis direction) of the protruding portion 34a changes in a manner that stepwise decreases the lateral width as the location of the lateral width changes from the main body portion toward a tip of the protruding portion 34a. The protruding portion 34b which is the other protruding portion also has a pair of inclined portions 34d and 34f which form a tapered shape. That is, the protruding portion 34b has a stair shape in which the lateral width of the protruding portion 34b changes in a manner that stepwise decreases the lateral width as the location of the lateral width changes from the main body portion toward a tip of the protruding portion 34b.

In the present embodiment, as in the first embodiment, a distance in each of the longitudinal direction and the lateral direction between the tip of the protruding portion 34a and an edge of one end portion of a slot 22s is set so as to be within one eighth of the wavelength λ. Similarly, a distance in each of the longitudinal direction and the lateral direction between the tip of the protruding portion 34b and an edge of the other end portion of the slot 22s is set so as to be within one eighth of the wavelength λ. As illustrated in FIG. 13, impedance adjusting units 26aF and 26bF of the present embodiment are formed near the both ends of the coupling conductor 34 in the X-axis direction.

Because the coupling conductor 34 has the protruding portions 34a and 34b facing the both end portions of the slot 22s as in the first embodiment, the hollow-waveguide-to-planar-waveguide transition circuit 7 of the present embodiment also can achieve low manufacturing cost and high operation reliability while suppressing unnecessary radiation.

### Eighth Embodiment

In the planar waveguide structure 20 of the first embodiment, as illustrated in FIG. 1, the slot 22s formed on the back surface of the dielectric substrate 21 has a rectangular shape, although no limitation thereto is intended. The slot may be deformed such that the width (width in the X-axis direction) of each slot at both end portions in a longitudinal direction is larger than the width (width in the X-axis direction) of each slot at the midportion.

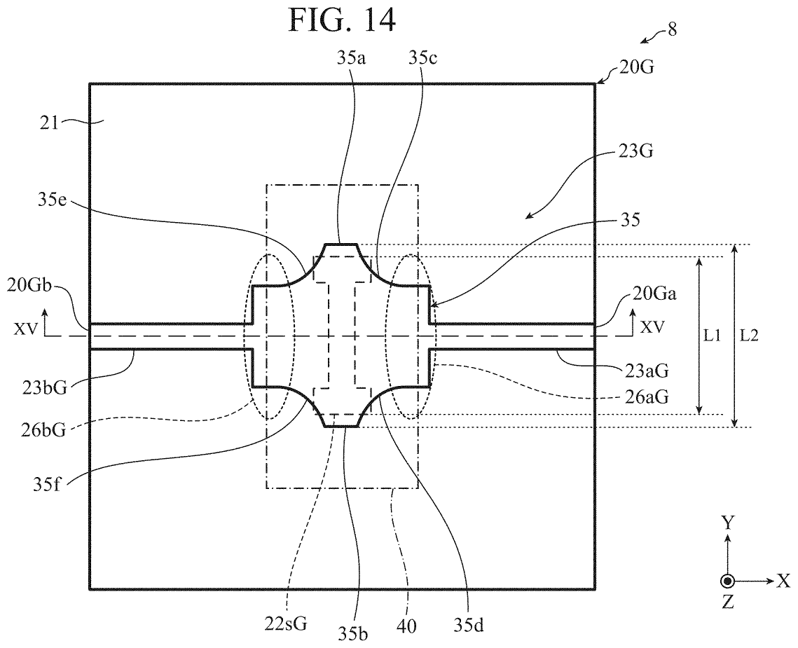

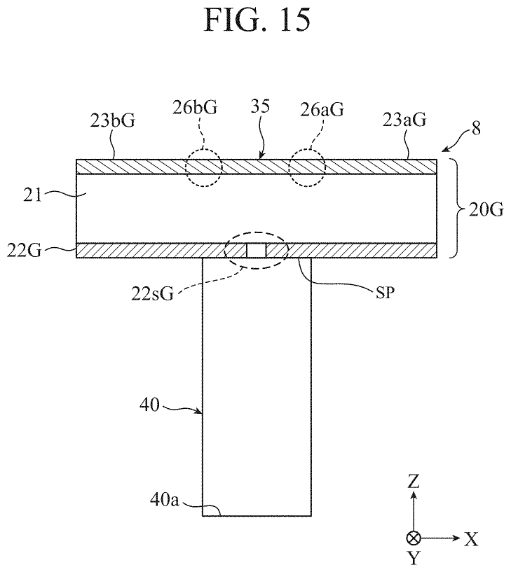

FIG. 14 is a view schematically illustrating the planar structure of a hollow-waveguide-to-planar-waveguide transition circuit 8 of an eighth embodiment according to the present invention. FIG. 15 is a schematic cross-sectional view taken along line XV-XV of the hollow-waveguide-to-planar-waveguide transition circuit 8 illustrated in FIG. 14.

The hollow-waveguide-to-planar-waveguide transition circuit 8 of the present embodiment includes a planar line structure 20G having input/output terminals 20Ga and 20Gb as illustrated in FIG. 14, and the planar line structure 20G has a conductor pattern 23G on the front surface of a dielectric substrate 21. As illustrated in FIG. 15, a ground conductor 22G is disposed on the back surface of the dielectric substrate 21. In the ground conductor 22G, a rectangular slot 22sG extending in the Y-axis direction is formed. As illustrated in FIG. 14, the width of the slot 22sG at both end portions in a longitudinal direction is larger than the width of the slot 22sG at the midportion.

The conductor pattern 23G includes strip conductors 23aG and 23bG extending in the X-axis direction and a coupling conductor 35 electrically coupled with the strip conductors 23aG and 23bG. The strip conductors 23aG and 23bG are disposed so as to extend in opposite directions to each other with respect to the slot 22sG. A main body portion of the coupling conductor 35 of the present embodiment is physically connected to inner end portions of the strip conductors 23aG and 23bG.

Like the coupling conductor 24 of the first embodiment, the coupling conductor 35 has protruding portions 35a and 35b protruding from the main body portion of the coupling conductor 35 in the Y-axis direction, and these protruding portions 35a and 35b have inclined portions 35c, 35e, 35d, and 35f each forming a tapered shape and are disposed so as to face, in the Z-axis direction, both end portions of the slot 22sG in the Y-axis direction. As illustrated in FIG. 14, impedance adjusting units 26aG and 26bG of the present embodiment are formed near the both ends of the main body portion of the coupling conductor 35 in the X-axis direction.

The lateral width (width in the X-axis direction) of a tip of the protruding portion 35a is narrower than the lateral width of one end portion of the slot 22sG in the Y-axis direction, and the lateral width (width in the X-axis direction) of a tip of the protruding portion 35b is also narrower than the lateral width of the other end portion of the slot 22sG in the Y-axis direction. A distance in each of a longitudinal direction (Y-axis direction) and a lateral direction (X-axis direction) between an edge of one end portion of the slot 22sG in the Y-axis direction and the tip of the protruding portion 35a is set so as to be equal to or less than one eighth (=λ/8) of the wavelength λ corresponding to a center frequency of a frequency band to be used. A distance in each of the longitudinal direction and the lateral direction between an edge of the other end portion of the slot 22sG in the Y-axis direction and the tip of the protruding portion 35b is similarly set so as to be equal to or less than λ/8.

As illustrated in FIG. 14, the size of the tip portion covering one end portion of the slot 22sG in the protruding portion 35a in the Y-axis direction is about the same as the size of one end portion of the slot 22sG. The size of the tip portion covering the other end portion of the slot 22sG in the protruding portion 35b in the Y-axis direction is also about the same as the size of the other end portion of the slot 22sG. Therefore, the function of the protruding portions 35a and 35b is substantially the same as the function of the protruding portions 24a and 24b of the first embodiment. Therefore, it is possible to efficiently transmit a high-frequency signal to the strip conductors 23aG and 23bG while suppressing unnecessary radiation.

The hollow-waveguide-to-planar-waveguide transition circuit 8 of the present embodiment also can achieve low manufacturing cost and high operation reliability while suppressing unnecessary radiation as in the first embodiment. In the present embodiment, furthermore, because the width of the slot 22sG at both end portions is larger than that at the midportion, a length L1 of the slot 22sG in a longitudinal direction (Y-axis direction) can be reduced (shortened) while a technical effect similar to that in the first embodiment is maintained. As a result, a length L2 of the conductor pattern 23G in the Y-axis direction can be reduced (shortened). Therefore, it is possible to miniaturize the hollow-waveguide-to-planar-waveguide transition circuit 8.

Note that such a slot 22sG can also be applied to the following ninth embodiment.

### Ninth Embodiment

In the first to eighth embodiments, the number of the input/output terminals of each of the planar waveguide structures 20 and 20A to 20G is two, although no limitation thereto is intended. The planar waveguide structure of each of the above embodiments may be modified so as to have four or more input/output terminals.

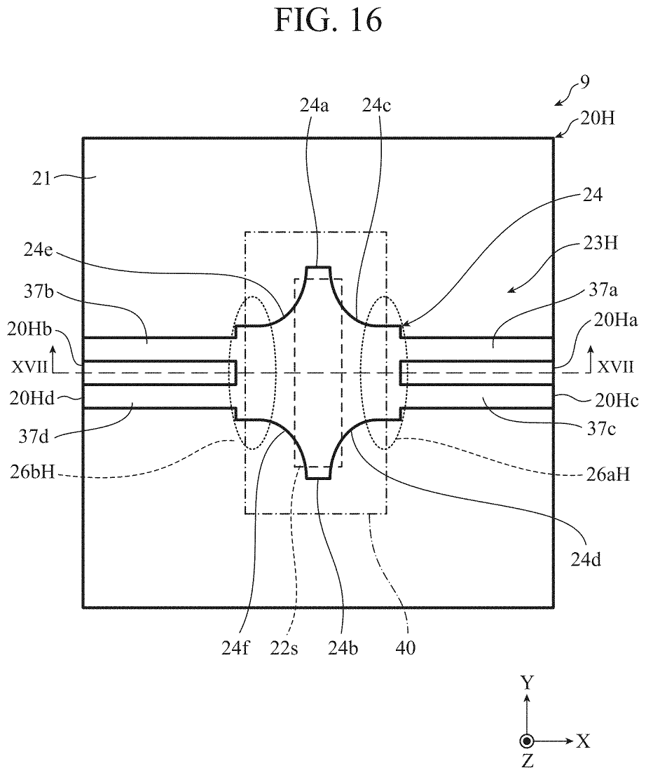

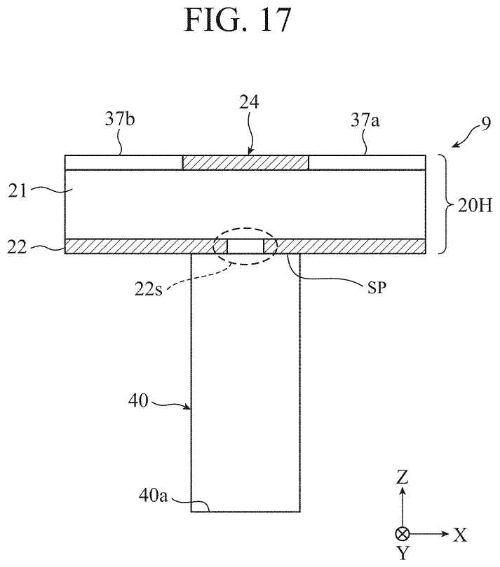

FIG. 16 is a view schematically illustrating the planar structure of a hollow-waveguide-to-planar-waveguide transition circuit 9 of a ninth embodiment which is a modification of the first embodiment. FIG. 17 is a schematic cross-sectional view taken along line XVII-XVII of the hollow-waveguide-to-planar-waveguide transition circuit 9 illustrated in FIG. 16. The configuration of the hollow-waveguide-to-planar-waveguide transition circuit 9 is the same as that of the hollow-waveguide-to-planar-waveguide transition circuit 1 of the first embodiment except for having a conductor pattern 23H of FIG. 16 instead of the conductor pattern 23 of FIG. 1. A step of forming the conductor pattern 23H is the same as the step of forming the conductor pattern 23.

The hollow-waveguide-to-planar-waveguide transition circuit 9 of the present embodiment includes a planar waveguide structure 20H having four input/output terminals 20Ha, 20Hb, 20Hc, 20Hd as illustrated in FIG. 16, and the planar waveguide structure 20H has the conductor pattern 23H on the front surface of a dielectric substrate 21. This conductor pattern 23H includes a coupling conductor 24 as in the first embodiment. The conductor pattern 23H further includes strip conductors 37a, 37b, 37c, and 37d which are linear conductors extending in the X-axis direction. All of the strip conductors 37a, 37b, 37c, and 37d are connected to the coupling conductor 24. As illustrated in FIG. 16, impedance adjusting units 26aH and 26bH are formed near both ends of the coupling conductor 24 in the X-axis direction.

When a high-frequency signal is input to a hollow waveguide 40, the input high-frequency signal excites a slot 22s. Because the longitudinal direction (Y-axis direction) of the slot 22s intersects the longitudinal direction (extending direction) of the strip conductors 37a, 37b, 37c, and 37d, the excited slot 22s and the strip conductors 37a, 37b, 37c, and 37d are magnetically coupled with each other. Then, the high-frequency signal is propagated via a parallel flat line to the input/output terminals 20Ha, 20Hb, 20Hc, and 20Hd of a microstrip line and output. Conversely, when high-frequency signals are input to the input/output terminals 20Ha, 20Hb, 20Hc, and 20Hd of the planar waveguide structure 20H, respectively, these high-frequency signals are combined and then output from an input/output terminal 40a of the hollow waveguide 40.

As described above, the planar waveguide structure 20H of the ninth embodiment has four input/output terminals 20Ha, 20Hb, 20Hc, and 20Hd, and therefore can implement the hollow-waveguide-to-planar-waveguide transition circuit 9 also having a function of a multi-divider.

Hereinabove, the various embodiments according to the present invention have been described with reference to the drawings, but these embodiments are examples of the present invention, and various forms other than those embodiments can be also adopted. Within the scope of the present invention, an arbitrary combination of the first to ninth embodiments, modification of any component of each embodiment, or omission of any component in each embodiment is possible.

### INDUSTRIAL APPLICABILITY

Because the hollow-waveguide-to-planar-waveguide transition circuit according to the present invention is used in a high-frequency transmission line for transmitting a high-frequency signal such as a millimeter wave or a microwave, it is suitable for use in an antenna device, radar device and communication device which operate in a high-frequency band such as a millimeter wave band or a microwave band.

### REFERENCE SIGNS LIST

1 to 9: Hollow-waveguide-to-planar-waveguide transition circuits; 20, 20A to 20H: Planar waveguide structures; 20a, 20b: Input/output terminals; 21: Dielectric substrate; 22, 22C: Ground conductors; 22s: Slot; 23, 23A to 23D, 23G, 23H: Conductor patterns; 23a, 23b, 23aA, 23bA, 23ab, 23bB, 23ac, 23bc: Strip conductors; 24, 25, 32, 33, 34, 35: Coupling conductors; 24a, 24b, 25a, 25b, 30a, 30b, 31a, 31b, 32a, 32b, 33a, 33b, 34a, 34b, 35a, 35b: Protruding portions; 40: Hollow waveguide; 40a: Input/output terminal; and SP: Short plane.

1. A hollow-waveguide-to-planar-waveguide transition circuit for transmitting a high-frequency signal, the hollow-waveguide-to-planar-waveguide transition circuit comprising:
a dielectric substrate having a first main surface and a second main surface which face each other in a thickness direction of the dielectric substrate;
one or more strip conductors formed on the first main surface, extending in a first in-plane direction determined in advance;
a ground conductor formed on the second main surface to face the one or more strip conductors in the thickness direction;
one or more slots formed in the ground conductor and extending in a second in-plane direction different from the first in-plane direction on the second main surface; and
a coupling conductor formed at a position to be electrically coupled with the one or more strip conductors on the first main surface, and disposed at a position facing the one or more slots in the thickness direction,
the coupling conductor having a main body portion electrically coupled with the one or more strip conductors, and having a protruding portion protruding from the main body portion in the second in-plane direction, the protruding portion being formed and facing, in the thickness direction, an end portion of the one or more slots in the second in-plane direction,
wherein a distance in the second in-plane direction between an edge of the end portion of the one or more slots and the tip of the protruding portion is equal to or less than one eighth of a wavelength corresponding to a center frequency of a predetermined frequency band for use in the high-frequency signal.

2. A hollow-waveguide-to-planar-waveguide transition circuit for transmitting a high-frequency signal, the hollow-waveguide-to-planar-waveguide transition circuit comprising:
a dielectric substrate having a first main surface and a second main surface which face each other in a thickness direction of the dielectric substrate;
one or more strip conductors formed on the first main surface, extending in a first in-plane direction determined in advance;
a ground conductor formed on the second main surface to face the one or more strip conductors in the thickness direction;
one or more slots formed in the ground conductor and extending in a second in-plane direction different from the first in-plane direction on the second main surface; and
a coupling conductor formed at a position to be electrically coupled with the one or more strip conductors on the first main surface, and disposed at a position facing the one or more slots in the thickness direction,
the coupling conductor having a main body portion electrically coupled with the one or more strip conductors, and having a protruding portion protruding from the main body portion in the second in-plane direction, the protruding portion being formed and facing, in the thickness direction, an end portion of the one or more slots in the second in-plane direction, wherein:
a tip of the protruding portion is disposed outside the end portion of the one or more slots in the second in-plane direction as viewed from the thickness direction; and
a width of the tip of the protruding portion in the first in-plane direction is narrower than an entire width of the one or more slots in the first in-plane direction.

3. A hollow-waveguide-to-planar-waveguide transition circuit for transmitting a high-frequency signal, the hollow-waveguide-to-planar-waveguide transition circuit comprising:
a dielectric substrate having a first main surface and a second main surface which face each other in a thickness direction of the dielectric substrate;
one or more strip conductors formed on the first main surface, extending in a first in-plane direction determined in advance;
a ground conductor formed on the second main surface to face the one or more strip conductors in the thickness direction;
one or more slots formed in the ground conductor and extending in a second in-plane direction different from the first in-plane direction on the second main surface; and
a coupling conductor formed at a position to be electrically coupled with the one or more strip conductors on the first main surface, and disposed at a position facing the one or more slots in the thickness direction,
the coupling conductor having a main body portion electrically coupled with the one or more strip conductors, and having a protruding portion protruding from the main body portion in the second in-plane direction, the protruding portion being formed and facing, in the thickness direction, an end portion of the one or more slots in the second in-plane direction,
wherein the protruding portion has a tapered shape in which a width of the protruding portion in the first in-plane direction changes in a manner that gradually decreases the width of the protruding portion as a location of the width of the protruding portion changes from the main body portion toward the tip of the protruding portion.

4. A hollow-waveguide-to-planar-waveguide transition circuit for transmitting a high-frequency signal, the hollow-waveguide-to-planar-waveguide transition circuit comprising:
a dielectric substrate having a first main surface and a second main surface which face each other in a thickness direction of the dielectric substrate;
one or more strip conductors formed on the first main surface, extending in a first in-plane direction determined in advance;
a ground conductor formed on the second main surface to face the one or more strip conductors in the thickness direction;
one or more slots formed in the ground conductor and extending in a second in-plane direction different from the first in-plane direction on the second main surface; and
a coupling conductor formed at a position to be electrically coupled with the one or more strip conductors on the first main surface, and disposed at a position facing the one or more slots in the thickness direction,
the coupling conductor having a main body portion electrically coupled with the one or more strip conductors, and having a protruding portion protruding from the main body portion in the second in-plane direction, the protruding portion being formed and facing, in the thickness direction, an end portion of the one or more slots in the second in-plane direction,
wherein the protruding portion has a stair shape in which a width of the protruding portion in the first in-plane direction changes in a manner that stepwise decreases the width of the protruding portion as a location of the width of the protruding portion changes from the main body portion toward the tip of the protruding portion.

5. (canceled)

6. The hollow-waveguide-to-planar-waveguide transition circuit according to claim 1, further comprising a hollow waveguide having one end portion connected to an area containing the one or more slots in the ground conductor.

7. The hollow-waveguide-to-planar-waveguide transition circuit according to claim 1, wherein a guide-axis direction of a hollow waveguide and the second main surface are orthogonal to each other.

8. The hollow-waveguide-to-planar-waveguide transition circuit according to claim 1, wherein the main body portion is physically connected to the one or more strip conductors.

9. The hollow-waveguide-to-planar-waveguide transition circuit according to claim 1, wherein the main body portion is disposed to be physically separated from the one or more strip conductors.

10. The hollow-waveguide-to-planar-waveguide transition circuit according to claim 9, wherein:
the strip conductors include a first strip conductor and a second strip conductor which are disposed to be separated from each other; and
the coupling conductor includes a first recessed portion that surrounds an end portion of the first strip conductor facing the coupling conductor, and includes a second recessed portion that surrounds an end portion of the second strip conductor facing the coupling conductor.

11. The hollow-waveguide-to-planar-waveguide transition circuit according to claim 1, wherein both end portions of each of the one or more slots have respective widths larger than a width of a midportion of said each of the one or more slots.
